(19) United States
(12) Patent Application Publication
(10) Pub. No.: US 2019/0218810 A1
(43) Pub. Date: Jul. 18, 2019

(54) Parking System for Detecting and Managing Occupied and Unoccupied Parking Spaces

(71) Applicant: ZF Friedrichshafen AG, Friedrichshafen (DE)

(72) Inventors: Bin Zhang, Tettnang (DE); Dan Oprisan, Achberg (DE)

(73) Assignee: ZF Friedrichshafen AG, Friedrichshafen (DE)

(21) Appl. No.: 16/247,371

(22) Filed: Jan. 14, 2019

(30) Foreign Application Priority Data
Jan. 15, 2018 (DE) DE102018200574.5

(51) Int. Cl. E04H 6/42; G05D 1/00; G05D 1/02; E04H 6/36; B25J 9/16; G06K 19/06

(52) U.S. Cl. CPC E04H 6/424; G05D 1/0088; G05D 1/0274; G06K 19/06037; G05D 1/0287; E04H 6/36; B25J 9/1679; G05D 1/0234

(57) ABSTRACT

A multidimensional code (1), which has encoded information that can be read by scanning the code, for marking a parking space (11, 12, 13) in a parking lot (10), wherein the code (1) can be located in the parking space (11, 12, 13) and the encoded information contains the number (2) assigned to the parking space (11, 12, 13). The invention also relates to use of a multidimensional code (1) according to the invention in a parking structure (14), a parking robot (20), a parking system (40), use of a parking system (40) according to the invention in a parking structure (14), and a process for automatically transporting and parking vehicles (5) in a parking lot (10) that has parking spaces (11, 12, 13), wherein the parking spaces (11, 12, 13) are each marked with a multidimensional code (1) according to the invention.

The invention relates to a multidimensional code for marking a parking space according to claim 1. The invention also relates to use of the multidimensional code according to the invention in a parking structure according to claim 5. Moreover, the invention relates to a parking robot according to claim 6. The invention also relates to a parking system according to claim 8. Furthermore, the invention relates to use of the parking system according to the invention according to claim 10. Lastly, the invention relates to a process for automated transportation and parking of vehicles in a parking lot with parking spaces according to claim 11.

Driverless systems are known from the prior art that relieve the driver of frequently inconvenient searches for parking spaces and parking maneuvers using networked technology. These parking systems, also referred to as Automated Valet Parking Systems, are based on a communication between a parking structure infrastructure and the vehicle. By way of example, a stationary sensor for determining the position of a vehicle moving in a parking structure is known. The stationary sensor is part of the parking facility. The relevant prior art is disclosed by way of example in US 20160318510 A1.

The known Automated Valet Parking Systems require an elaborate infrastructure of parking elements, in particular a large number of stationary sensors that communicate with position detection devices in vehicles entering the parking lot.

This is the basis for the invention. The fundamental object of the invention is to create a parking system that simplifies automated vehicle parking in empty parking spaces in a parking structure and enables a mixed operation of a parking facility with driverless vehicles and vehicles driven by a person.

This problem is solved by a multidimensional code that has the features of claim 1, use of the multidimensional code according to the invention in a parking structure according to claim 5, a parking robot that has the features of claim 6, a parking system that has the features of claim 8, use of the parking system that has the features of claim 10, and by a process that has the features of claim 11.

Advantageous designs and further developments of the invention are the subject matter of the dependent claims.

A multidimensional code containing encoded information that can be read by scanning the code, is provided according to the invention for marking a parking space in a parking lot. The code can be assigned to the parking space such that when the parking space is occupied by a vehicle the code is concealed by the vehicle. According to the invention, the encoded information comprises the number assigned to the parking space.

Multidimensional codes are preferably symbols that can be read, preferably opto-electronically, comprised of different, preferably geometric, elements and spaces therebetween, with very high contrast. Information is encoded in not just one direction, but rather in the form of a multidimensional object, e.g. a surface. In comparison with a single-dimensional code, e.g. a bar code, a multidimensional code has the advantage that a higher density of useful information is obtained. By way of example, a two-dimensional code in the form of a two-dimensional surface forms a multidimensional code. One example of a two-dimensional code is a Quick Response Code, abbreviated as QR code, disclosed, e.g. in EP 0 672 994 A1.

Encoded information in a multidimensional code comprises depicting the information in symbols.

The encoded information can be read by scanning the code. Scanning the code involves scanning encoded information relating to a technical device, e.g. an optical sensor. The technical device decodes the information and processes such to solve a technical problem with technical means. By way of example, the encoded information in a Quick Response code is read mechanically with scanners, preferably optical scanners such as camera scanners, and electronically processed, e.g. as a signal sent to a parking system. This information does not relate to human intelligence, but instead to a technical device that first has to decode this code. There are thus no technical effects on humans. The technical problem that is solved with multidimensional codes is the marking of a parking space in a parking lot.

A parking space is a delimited area in a public traffic area. The parking space is used for parking vehicles. A parking lot is a coherent area comprising numerous parking spaces. Connecting paths within the parking lot are referred to driving lanes.

The feature of the code, specifically that it can be assigned to the parking space such that when the parking space is occupied by a vehicle the code is concealed by the vehicle, has the advantage that the code cannot be scanned when the parking space is occupied. If a code is scanned in a parking system, then the associated parking space is unoccupied.

It can be determined which parking spaces are occupied or unoccupied on the basis of the numbers assigned to the parking spaces. If, for example, the numbers 10, 11, 13, and 14 are scanned in a row of parking spaces after an appropriate decoding of the multidimensional codes applied thereto, the parking system then knows that the parking space with the number 12 is occupied.

Advantageously, the code can be printed on the ground and/or wall surface of the parking space. The code can be assigned by printing it thereon in a particularly simple manner, such that it is concealed when a vehicle is occupying the parking space.

In a particularly advantageous configuration of the invention, the encoded information contains the coordinates of the parking space and/or rights of use for this parking space.

Based on the coordinates of the parking space, a parking robot that scans the code can determine its position in relation to the parking space. The determination of the position in relation to environmental features is generally known as Simultaneous Localization and Mapping, abbreviated SLAM. The encoded coordinates of the parking space thus enable a SLAM process, by means of which a parking robot can navigate in a parking lot. This is particularly advantageous in closed parking structures in which wireless communication with external devices is not possible. In-house navigation there is improved with SLAM.

Rights of use for the parking space refer to the rights for specific types of vehicles that are allowed to park in this parking space. By way of example, a parking space identified as a handicap parking space has rights of use for handicapped drivers. Further examples of rights of use are women's parking spaces, family parking spaces or motorcycle parking spaces.

The multidimensional code is preferably a Quick Response code. Numerous scanners and decoding methods are known for Quick Response codes.

According to the invention, a multidimensional code according to the invention is used for marking parking spaces, preferably in a parking structure. As a result, parking spaces can be readily marked for a parking system.

The parking robot according to the invention is configured to transport a vehicle in a parking lot from a transfer area to a parking space and/or from the parking space to the transfer area, and to detect available parking spaces. The parking robot according to the invention has an input interface. The input interface is configured to obtain data regarding occupation and/or driving lanes in the parking lot. Furthermore, the parking robot has a scanner. The scanner is configured to scan and read the multidimensional codes according to the invention in parking spaces. Furthermore, the parking robot has an output interface. The output interface is configured to determine which parking spaces are unoccupied based on the codes that have been scanned. The parking robot is configured to position the vehicle in the parking space based on the data and the codes that have been scanned.

A parking robot is a transport unit configured to transport vehicles and position them in a parking space. The parking robot has a base element and a drive device. A vehicle is positioned with the base element. The drive device transports the vehicle with the parking robot.

The transfer area, also referred to as the drop-off zone, is the region where the driver gives his vehicle to the Automated Valet Parking System. Advantageously, the transfer area is in an entry to the parking lot, or a parking level in a parking structure.

An interface is a device between at least two functional units where an exchange of logical variables, e.g. data, or physical data, e.g. electrical signals, takes place, either unidirectionally or bidirectionally. The exchange can be analog or digital. The exchange can be wireless or wired. An interface can exist between software and software, hardware and software, as well as software and hardware and hardware and software.

The scanner has an optical sensor, preferably a camera, with which the code is scanned. Furthermore, the scanner is configured to execute an algorithm with which the code is decoded and eliminate typical display errors.

Advantageously, the parking robot is configured to navigate the parking lot based on the encoded coordinates of the parking spaces. As a result, the parking robot can determine its own location in the parking lot in relation to the codes, e.g. by means of Simultaneous Localization and Mapping, SLAM.

The parking system according to the invention includes a parking lot with parking spaces. The parking spaces are each marked with a multidimensional code according to the invention. Furthermore, the parking system has a parking robot according to the invention. Moreover, the parking system has a parking evaluation device. The parking evaluation device is configured to inform the parking robot of available driving lanes and/or to update the numbers of the available parking spaces on the basis of the codes scanned by the parking robot.

The parking evaluation device is a device that processes incoming information and outputs the results. In particular, the parking evaluation device is an electronic circuit, e.g. a central processing unit.

In a further development of the parking system according to the invention, the parking system has a fleet of parking robots. The parking system can the employ the capabilities of the individual parking robots in a targeted manner and uses the fleet of parking robots to manage occupied and unoccupied parking spaces in a parking lot or in a parking structure, in a manner similar to swam intelligence.

The parking system is used according to the invention in a parking structure.

The parking spaces are each marked with a multidimensional code according to the invention for the process according to the invention for automatically transporting and parking vehicles in a parking lot with parking spaces. The process has the following steps:
transfer of a vehicle in a transfer area,
selection of an available target parking space in the parking with a parking evaluation device,
provision of a parking robot by the parking evaluation device, based on the selected target parking space,
transportation of the vehicle to the target parking space by the parking robot,
scanning and reading the multidimensional codes by the parking robot during transport, and supplying decoded information to the parking evaluation device,
parking the vehicle in the target parking space based on the decoded information and notifying the parking evaluation device of the occupation thereof,
continuation of travel by the parking robot in the parking lot, and
scanning and reading the multidimensional codes by the parking robot during the continuation, and supplying decoded information to the parking evaluation device in order to update the occupation data for the parking lot.

The advantages of the process according to the invention in comparison with known Automated Valet Parking Systems comprise reduced demands on the infrastructure of the parking device.

The parking robot preferably transports the vehicle from the target parking space to the transfer area and supplies the number assigned to the unoccupied target parking space to the parking evaluation device based on the data in the parking evaluation device.

The parking evaluation device tells the parking robot which driving lanes to use for transporting the vehicle in an advantageous design of the process. It is ensured in this manner that areas of the parking lot that are not often frequented in normal operation of the parking system are also patrolled by parking robots.

According to a further development of the invention, the parking evaluation device provides a fleet of parking robots, and dictates which driving lanes are available to the parking robots in the fleet for transporting the vehicle.

A parking robot according to the invention and/or a parking system according to the invention are preferably used for executing the process.

The invention shall be explained comprehensively based on the following figures. Therein:

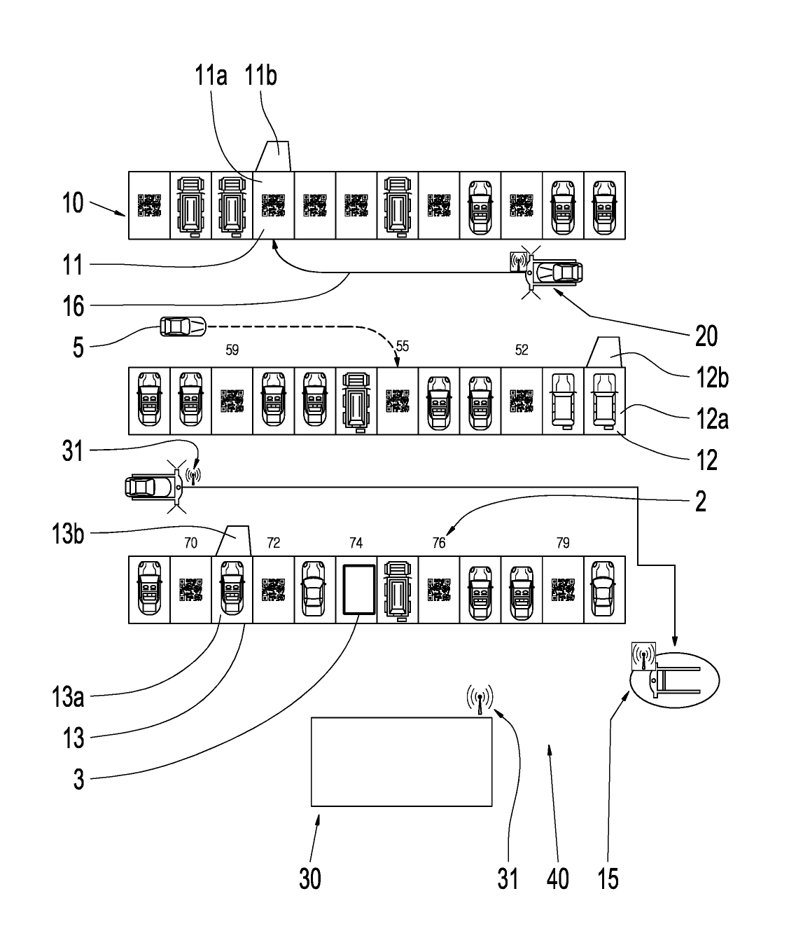

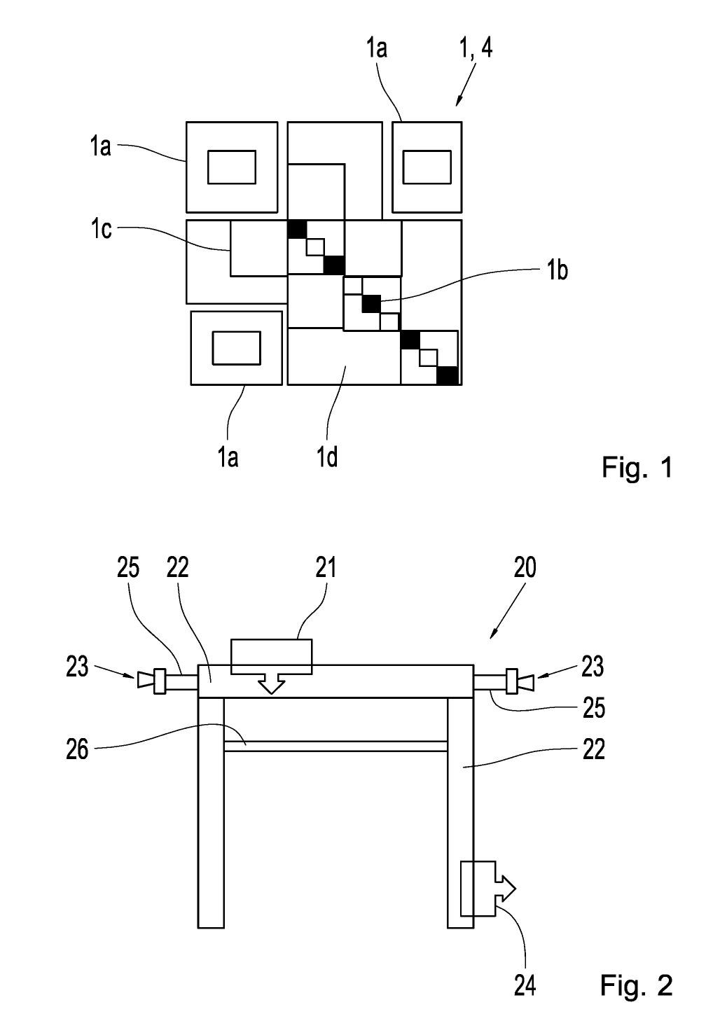

FIG. 1: shows an exemplary embodiment of a multidimensional code according to the invention,

FIG. 2: shows an exemplary embodiment of a parking robot according to the invention,

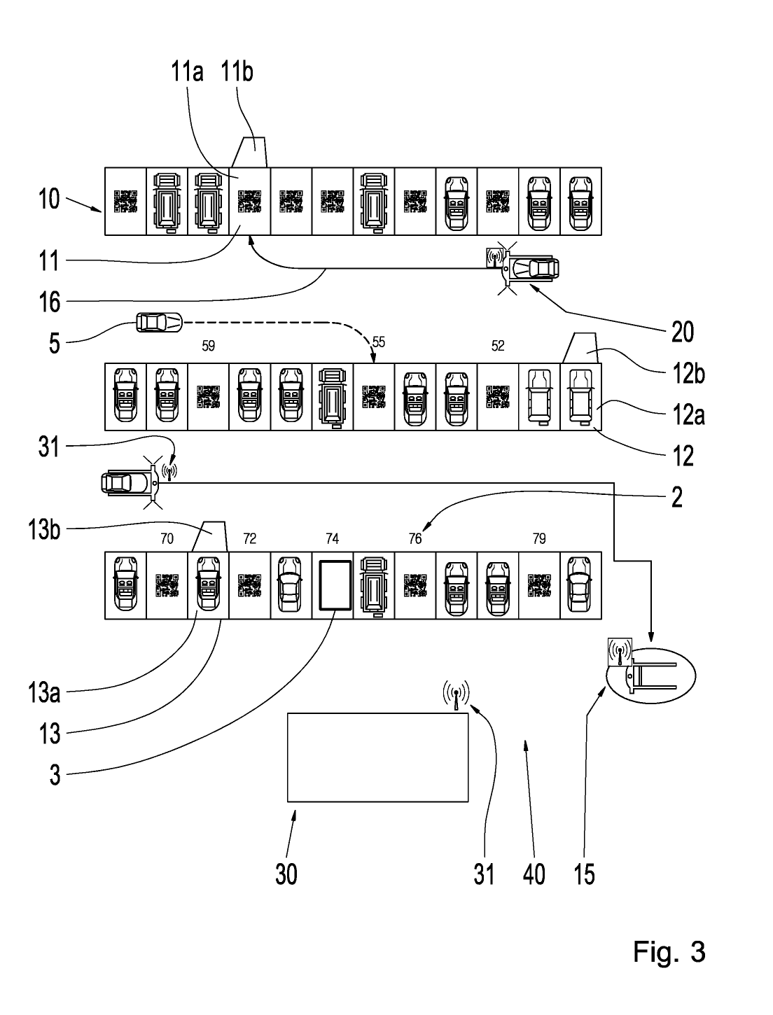

FIG. 3: shows an exemplary embodiment of a parking system according to the invention,

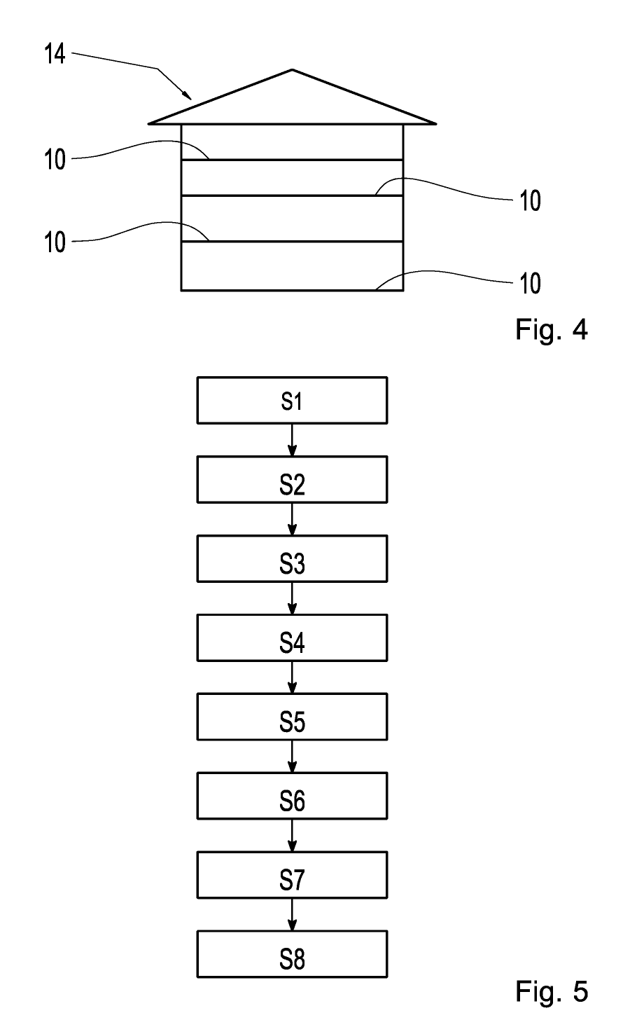

FIG. 4: shows an exemplary embodiment of a parking structure, and

FIG. 5: shows an exemplary embodiment of a process according to the invention.

The same reference symbols are used in the figures for identical elements, or elements having similar functions. The respective relevant elements are indicated by the associated reference symbols in the relevant figures.

FIG. 1 shows a multidimensional code 1 in the form of a Quick Response Code 4. The Quick Response Code 4 is in the shape of a square. The Quick Response Code 4 can be printed with known printing technology methods. In order to obtain a maximum contrast, the multidimensional code 1 is preferably printed in black and white. It is also possible to print the Quick Response Code 4 in color, wherein the colors preferably represent a further encoding possibility. The Quick Response Code 4 can be of any size. It is only necessary that a scanner 23 is able to distinguish and scan the entire Quick Response Code 4.

The Quick Response Code 4 has a positioning symbol 1a in three of the four corners. The Quick Response Code 4 can be read in any orientation due to the positioning symbols 1a. Information is decoded in cells 1c. The cells 1c are arranged in a two-dimensional field 1d. The cells 1c comprise data encoded in binary language for example. A time code 1b comprising alternating black and white squares along a diagonal through the Quick Response Code 4 simplifies the positioning of cells 1c in the Quick Response Code 4. A Quick Response Code 4 is described in general in EP 0 672 994 A1.

A parking robot 20 is shown in FIG. 2. The parking robot 20 has a base element 22. A vehicle 5 is accommodated, transported and/or positioned in a parking space 11 by the parking robot 20 with the base element 22. The parking robot 20 also has a drive device 25. The drive device 25 comprises electrically driven axles and wheels, for example. Furthermore, the parking robot 20 has a displacement element 26. The vehicle 5 arranged on the parking robot 20 using the displacement element 26. The parking robot 20 can be driven into position beneath a vehicle.

The parking robot 20 has scanners 23, each of which are located on the side of the drive device 25. When the parking robot 20 drives down driving lanes 16, the parking spaces, and thus the Quick Response Codes 4 are normally at a right angle to the parking robot 20. With scanners 23 mounted on the sides, the Quick Response Codes 4 are thus located in the direct lines of sight of the scanners 23. The scanners 23 are optical sensors that belong to the fundamental equipment of the parking robot 20.

The parking robot 20 receives data regarding occupancy and/or the driving lanes 16 in a parking lot 10 via an input interface 21. The parking robot 20 then outputs which parking spaces 11, 12, 13 are available via an output interface.

FIG. 3 shows a parking system 40. The parking system 40 has at least one parking lot 10. The parking lot 10 can be a level of a parking structure 14. Furthermore, the parking system 40 has a parking evaluation device 30. The parking evaluation device 30 is a server, for example, that communicates via a wireless communication device 31 with a transfer area 15 and a fleet of parking robots 20. The communication is wireless via WLAN. The parking system 40 is an Automated Valet Parking System enabling operation and management of a parking lot with parking robots 20 and with vehicles 5 driven by drivers.

The parking robots 20 move customer vehicles 5 from the transfer area 15 to a target parking space 11. If a vehicle driver needs the vehicle 5 that is parked in the target parking space 11, a parking robot 20 transports the vehicle 5 from the target parking space 11 back to the transfer area 15. The parking robot 20 also scans unoccupied and occupied parking spaces while transporting vehicles 5 to parking spaces 11, and transmits this information to the parking evaluation device 30. Occupancy of a parking space is detected by scanning the Quick Response Codes 4 printed on the floor 11a, 12a, 13a or a wall surface 11b, 12b, 13b of the parking space 11, 12, 13. The Quick Response Code 4 is scanned by the scanner 23 on the parking robot 20.

The Quick Response Code 4 encodes the number 2 assigned to the parking space, and the rights of use for this parking space. It can be determined which parking spaces are occupied on the basis of the numbers assigned to the parking spaces. If parking spaces 30 and 33 are unoccupied, for example, or not recorded as occupied, then the parking spaces assigned the numbers 31 and 32 must be occupied. The parking robot 20 is better able to determine its position in the parking lot 10 based on the coordinates of the respective parking spaces 11, 12, 13 that are encoded in the Quick Response Code 4, e.g. via Simultaneous Localization and Mapping, abbreviated as SLAM. This is advantageous for precise indoor navigation.

The parking evaluation device 30 is configured to store the occupancy status of all of the parking spaces 11, 12, 13 in the parking lot 10 by communicating with the parking robots 20. After a parking robot 20 has picked up a vehicle 5 in the transfer area 15, the parking evaluation device 30 determines the target parking space 11 for this parking robot 20. While the parking robot 20 is underway to the target parking space 11, the status of the target parking space 11 can be subsequently modified by the parking evaluation device. This is advantageous, e.g., when the original parking space 11 becomes occupied by a vehicle 5 driven by a driver, and the occupancy of this parking space 11 is conveyed to the parking evaluation device by another parking robot 20 passing this parking space 11.

It may also be the case that the parking robot 20 reaches its target parking space 11 only to discover that this target parking space 11 is already occupied by a vehicle driven by a driver, without the parking evaluation device 30 being informed of this. In this case, the parking robot 20 continues, and searches for the next unoccupied target parking space 11 in the immediate vicinity and reports the occupancy to the parking evaluation device 30.

The parking evaluation device 30 selects various target parking spaces 11 for various parking robots 20, in particular such that the entire parking lot 10 of the parking structure 14 is constantly and uniformly monitored by parking robots 20. This means that the parking evaluation device 30 may not necessarily select the next available parking space 11 for a parking robot 20, but instead may also allow a parking robot 20 to drive a further distance in the parking lot 10.

The main advantage of this parking system 40 in comparison with existing Automated Valet Parking Systems is that, with a given infrastructure of a parking system, expensive equipping of the parking system with further sensors is not necessary. The parking system 40 be easily integrated in an existing parking structure 14 by printing parking spaces 11, 12, 13 with Quick Response Codes 4 and using existing parking robots 20.

The parking structure 14 is shown in FIG. 4. This parking structure 14 has four levels, each of which comprises a parking lot 10. The parking robots 20 drive through parking lots on different levels. It may also be the case that there is a separate fleet of parking robots 20 for each level.

The process steps are shown in FIG. 5. In step S1, a vehicle 5 is given over in the transfer area. By way of example, a driver drives his vehicle 5 into a parking structure 14 and surrenders his vehicle to the parking system 40 in the transfer area.

In step S2, an available target parking space 11 in the parking lot 10 is selected by the parking evaluation device 30.

Depending on the selected target parking space, a parking robot 30 is provided by the parking evaluation device 30 in step S3.

In step S4, the parking robot 20 transports the vehicle 5 to the target parking space 11.

During transport, the parking robot 20 scans and reads multidimensional codes printed on the parking spaces 11, 12, 13, and supplies decoded information to the parking evaluation device 30 in step S5. The vehicle 5 is parked in step S6, based on the selection of the target parking space 11 and the decoded information, and this occupancy is conveyed to the parking evaluation device 30. After the vehicle 5 has been placed in the parking space 11, the parking robot 20 continues traveling in the parking lot 10 in step S7, and scans and reads multidimensional codes 10 thereby. Decoded information is supplied to the parking evaluation device 30 in step S8, in order to update the occupancy information for the parking lot 10. As a result, the occupancy status of the parking lot 10 is detected dynamically.

### LIST OF REFERENCE SYMBOLS

1 multidimensional code

1a positioning symbol

1b time code

1c cell

1d field

2 number

3 object

4 Quick Response Code

5 vehicle

10 parking lot

11 parking space

11a floor surface

11b wall surface

12 parking space

12a floor surface

12b wall surface

13 parking space

13a floor surface

13b wall surface

14 parking structure

15 transfer area

16 driving lane

20 parking robot

21 input interface

22 base element

23 scanner

24 output interface

25 drive device

26 displacement element

30 parking evaluation device

31 communication device

40 parking system

S1-S8 process steps

1. A multidimensional code, which has encoded information that can be read by scanning the code, for marking a parking space in a parking lot, wherein
the code can be placed in the parking space such that when the parking space is occupied with a vehicle, the code is concealed by the vehicle, and
the encoded information contains the number assigned to the parking space.

2. The multidimensional code according to claim 1, characterized in that the code can be printed on the floor and/or wall surface of the parking space.

3. The multidimensional code according to claim 1, characterized in that the information contains the coordinates of the parking space and/or a rights of use for the parking space.

4. The multidimensional code according to claim 1, characterized in that the code is a Quick Response code.

5. Use of a multidimensional code according to claim 1 for marking parking spaces preferably in a parking structure.

6. A parking robot configured to transport a vehicle in a parking lot from a transfer area to a parking space and/or from the parking space to the transfer area, and to detect available parking spaces, which has
an input interface configured to receive data regarding occupancy and/or driving lanes in the parking lot,
a scanner configured to scan and read multidimensional codes according to claim 1 that are located in the parking spaces, and
an output interface configured to output the available parking spaces based on the codes that have been read,
wherein the parking robot is configured to position the vehicle in the parking space based on the codes that have been read.

7. The parking robot according to claim 6, characterized in that the parking robot is configured to navigate in the parking lot based on encoded coordinates of the parking spaces.

8. A parking system that has
a parking lot with parking spaces, wherein the parking spaces are each marked with a multidimensional code according to claim 1,
parking robots according to claim 6, and
a parking evaluation device, wherein the parking evaluation device is configured to indicate the parking robots, driving lanes and/or numbers of available parking spaces and to update the driving lanes and/or the numbers of the available parking spaces based on the codes read by the parking robots.

9. The parking system according to claim 8, characterized in that the parking system has a fleet of parking robots.

10. Use of a parking system according to claim 8 in a parking structure.

11. A process for automatically transporting and parking vehicles in a parking lot that has parking spaces, wherein the parking spaces are each marked with a multidimensional code according to claim 1, which has the following steps:
dropping off a vehicle in a transfer area,
selection of an available target parking space in the parking lot with a parking evaluation device,
provision of a parking robot by the parking evaluation device based on the selected target parking space
transportation of the vehicle to the target parking space by the parking robot,
scanning and reading the multidimensional codes by the parking robot during transport, and outputting the decoded information to the parking evaluation device
parking the vehicle and outputting the occupancy of this parking space to the parking evaluation device based on the target parking space and the decoded information,
continuation of the travel of the parking robot in the parking lot, and
scanning and reading the multidimensional codes by the parking robot during the continued travel, and outputting the decoded information to the parking evaluation device in order to update the occupancy status of the parking lot.

12. The process according to claim 11, characterized in that
the parking robot transports the vehicle from the target parking space to the transfer area based on the data in the parking evaluation device, and
the parking robot outputs the number target parking space that has become available to the parking evaluation device.

13. The process according to claim 11, characterized in that the parking evaluation device dictates which driving lanes are available to the parking robot for transporting the vehicle.

14. The process according to any of the claim 11, characterized in that the parking evaluation device controls a fleet of parking robots and dictates which driving lanes are available to the parking robots in the fleet for transporting vehicles.

15. The process according to any of the claim 11, characterized in that a parking robot according to claim 6, and/or a parking system according to claim 8, are used for executing the process.

16. The multidimensional code according to claim 2, characterized in that the information contains the coordinates of the parking space and/or a rights of use for the parking space.

17. The multidimensional code according to claim 2, characterized in that the code is a Quick Response code.

18. Use of a multidimensional code according to claim 2 for marking parking spaces, preferably in a parking structure.

19. The process according to claim 12, characterized in that the parking evaluation device dictates which driving lanes are available to the parking robot for transporting the vehicle.

20. The process according to any of the claim 12, characterized in that the parking evaluation device controls a fleet of parking robots and dictates which driving lanes are available to the parking robots in the fleet for transporting vehicles.
